(19) United States
(12) Patent Application Publication
(10) Pub. No.: US 2006/0099909 A1
(43) Pub. Date: May 11, 2006

(54) Mobile communication terminal with global positioning system

(75) Inventor: Seock Jun Chang, Seoul (KR)

Correspondence Address: JONATHAN Y. KANG, ESQ.;LEE, HONG, DEGERMAN, KANG & SCHMADEKA, P.C., 14th Floor, 801 S. Figueroa Street, Los Angeles, CA, 90017-5554, US

(73) Assignee: LG Electronics Inc.

(21) Appl. No.: 11/271,255

(22) Filed: Nov. 10, 2005

(30) Foreign Application Priority Data
Nov. 10, 2004 (KR) 10-2004-0091380

(51) Int. Cl. H04B 7/185

(52) U.S. Cl. 455/12.1

(57) ABSTRACT

A mobile communication terminal with a Global Positioning System (GPS) receiver is disclosed. The mobile communication terminal comprises an antenna configured to receive a radio telecommunication signal for terrestrial communication and a GPS signal, an antenna matching circuit coupled to the antenna for impedance matching of the GPS signal, a first amplifier operationally connected to the antenna matching circuit for amplifying the GPS signal, and an RF switch operationally connected to the first amplifier for outputting one of a first amplifier output and another input to a first RF filter.

### CROSS-REFERENCE TO RELATED APPLICATIONS

This application claims the priority under 35 U.S.C. §119 for Korean Patent Application No. 10-2004-0091380, filed on Nov. 10, 2004, which is hereby incorporated by reference as if fully set forth herein.

### FIELD OF THE INVENTION

The present invention relates to a mobile communication terminal, and more particularly to a receiver apparatus for reducing a noise figure (NF) of a mobile communication terminal using a Global Positioning System (GPS) antenna.

### BACKGROUND OF THE INVENTION

Generally, Code Division Multiple Access (CDMA) mobile terminals capable of performing a GPS function using a satellite have been designed to support not only at least one of a digital cellular network (DCN) having a frequency band of 800 MHz, a personal communication service (PCS) having a frequency band of 1.8 GHz or 1.9 GHz, but also a GPS having a frequency band of 1.5 GHz.

The CDMA mobile terminals are classified into a dual-band terminal equipped with either the DCN and GPS or the PCS and GPS, and a tri-band terminal equipped with the DCN, PCS, and GPS.

The CDMA terminal is operated in one or more bands irrespective of its categories indicative of the dual-band terminal and the tri-band terminal, such that it requires a circuit for separating a Radio Frequency (RF) signal received via a single antenna supporting a multi-band into individual band circuits.

FIG. 1 is a block diagram illustrating a receiver of a mobile communication terminal using a tri-band antenna, wherein the mobile communication receiver comprises a tri-band antenna 110 for receiving a signal; an electrically controlled SP3T (single pole, triple throw) switch 120 for switching the signal received via the tri-band antenna 110 according to individual modes; a DCN duplexer 130 for receiving a DCN signal and separating only a reception frequency signal from the received DCN signal; a PCS duplexer 140 for receiving a PCS signal and separating only a reception frequency signal from the received PCS signal; an RF band-pass filter (BPF) 150 for receiving an RF signal of a GPS band and separating only a reception frequency signal from the received RF signal; and a controller (not shown) for receiving a signal from the tri-band antenna 110, transmitting a branch control signal capable of switching the received signal according to individual modes to the SP3T switch 120.

FIG. 2 is a block diagram illustrating a GPS receiver using a tri-band antenna according to a related art. The GPS receiver includes: a tri-band antenna 11 for receiving all GPS signals from individual base stations or satellites; an antenna matching circuit 12 for matching impedance of the RF signal received; an RF mobile switch 13 for measuring wireless conductivity performance of the mobile communication terminal; an electrically controlled SP3T switch 14 for receiving a signal from the tri-band antenna 11 and switching a single input signal to one of three output terminals; a first GPS Surface Acoustic Wave (SAW) filter 15 for passing only a predetermined-band signal from among a high-frequency signals; a GPS Low Noise Amplifier (LNA) 16 for amplifying the signal received from the first GPS RF SAW filter 15; and a second GPS RF SAW filter 18 for passing only a predetermined-band signal from among a high-frequency signals and for transmitting the passed signal to a frequency converter 19 that converts RF frequency to a baseband frequency.

The SP3T switch 14 shown in FIG. 2 and the SP3T switch 120 shown in FIG. 1 are the same switch. In FIG. 2, line loss 17 is indicative of a loss value generated when a GPS signal is applied to an internal circuit of the tri-mode terminal and is then applied to the frequency converter 19.

FIG. 3 is a block diagram illustrating a conventional mobile communication receiver using a GPS antenna. The receiver shown in FIG. 3 is configured with a dual-band antenna 110 for supporting PCS and DCN bands and a separate GPS antenna 250.

A signal received via the dual-band antenna 210 is applied to a diplexer 220. If the received signal is a PCS signal, the received signal is switched to the PCS duplexer 240. If the received signal is a DCN signal, the received signal is switched to the DCN duplexer 230. A GPS signal is received via the GPS antenna 250, and directly applied to an RF BPF 260.

FIG. 4 is a block diagram illustrating a related art GPS receiver using a GPS antenna. The GPS receiver includes a GPS antenna 21 for receiving all GPS signals from satellites; an antenna matching circuit 22 for matching impedance of an RF signal received; an RF mobile switch 23 for measuring wireless conductivity performance of the mobile communication terminal; a first GPS RF SAW filter 24 for passing only a predetermined-band signal from among a high-frequency signals received via the antenna (ANT) matching circuit 22; a GPS LNA 25 for receiving a signal generated from the first GPS RF SAW filter 24, and for amplifying the received signal; and a second GPS RF SAW filter 27 for passing only a predetermined-band signal from among a high-frequency signal received via the GPS LNA 25, and for transmitting the passed signal to an frequency converter 28.

Similar to FIG. 2, the line loss 27 is indicative of a loss value generated when a GPS signal is applied to an internal circuit of the tri-mode terminal and is then applied to the frequency converter 28.

The following Table 1 shows gains and NFs (Noise Figures) of individual components for use in the mobile communication terminal's receiver shown in FIG. 2.

TABLE 1

| Category | Gain (dB) | NF (dB) |
|---|---|---|
| RF mobile switch | −0.6 | 0.6 |
| SP3T | −0.6 | 0.6 |
| First GPS RF SAW filter | −0.7 | 0.7 |
| GPS LNA | 15 | 1.2 |
| Line loss | −0.5 | 0.5 |
| Second GPS RF SAW filter | −0.7 | 0.7 |
| frequency converter | 64 | 2 |

FIG. 5 is a diagram illustrating a method for calculating the above-mentioned NF. An equation for calculating a total NF using the components shown in FIG. 5 is shown in the following equation 1:

$$F = {F}_{1} + \frac{{F}_{2} - 1}{{G}_{1}} + \frac{{F}_{3} - 1}{{G}_{1} {G}_{2}} + … \frac{{F}_{N} - 1}{{G}_{1} {G}_{2} {G}_{3} … {G}_{N - 1}} \qquad [ Equation 1 ]$$

where NF=10 log F, and
where Gain=10 log G

According to Equation 1, the total NF of the GSP receiver is equal to 2.61 dB.

The following Table 2 shows gains and NFs (Noise Figures) of individual components for use in the mobile communication terminal's receiver shown in FIG. 4. In this case, the total NF is equal to 3.21 dB.

TABLE 2

| Category | Gain (dB) | NF (dB) |
|---|---|---|
| RF mobile switch | −0.6 | 0.6 |
| First GPS RF SAW filter | −0.7 | 0.7 |
| GPS LNA | 15 | 1.2 |
| Line loss | −0.5 | 0.5 |
| Second GPS RF SAW filter | −0.7 | 0.7 |
| frequency converter | 64 | 2 |

The above-mentioned conventional GPS receivers shown in FIGS. 2 and 4 receive GPS signals via their antennas, and transmit the received GPS signals to the frequency converter units 19 and 28 via their RF connection components, respectively. However, since GPS LNAs contained in the frequency converter units 19 and 28 have high NF values, the conventional GPS signal receivers additionally use external GPS LNAs 16 and 25, such that the external GPS LNAs 16 and 25 amplify low signals generated from the first GPS RF SAW filters 15 and 24, and reduce a total NF of a system. If the GPS signal is received from an antenna directly, it is applied to the RF mobile switch and the GPS RF SAW filter. Therefore, the total NF of a system is at least 3 dB when the tri-band antenna is used whereas the total NF of the system is at least 2.5 dB when the GPS antenna is used.

In other words, several passive components, each of which increases an NF until a GPS RF signal is applied to the GPS LNA, are located prior to the GPS LNA causing the total NF of a system to be increased, resulting in the deterioration of the mobile communication terminal GPS reception sensitivity.

### SUMMARY OF THE INVENTION

Accordingly, the present invention is directed to an apparatus and method for receiving a GPS signal in a mobile communication terminal that substantially obviates one or more problems due to limitations and disadvantages of the related art.

An object of the present invention is to provide a GPS receiver having a low NF in a tri-mode mobile communication terminal.

Another object of the present invention is to provide a GPS signal receiver for increasing GPS signal reception sensitivity of a mobile communication terminal.

Another object of the present invention is to provide an apparatus and method for reducing a distance error of a GPS signal.

Still another object of the present invention is to provide an apparatus and method for reducing a total NF of a mobile communication terminal GPS receiver to a predetermined value of 1 dB and less.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a global positioning system (GPS) receiver comprises an antenna for receiving a GPS signal; an antenna matching circuit coupled to the antenna for impedance matching; a first amplifier operationally connected to the antenna matching circuit for amplifying the GPS signal; and an RF switch operationally connected to the first amplifier for outputting one of a first amplifier output and another input to a first RF filter. The GPS receiver further comprises a second amplifier operationally connected to the RF switch for amplifying a first RF filter output; a second RF filter operationally connected to the second amplifier to provide bandpass filtering; a frequency converter operationally connected to the second RF filter for converting an RF signal to a baseband signal; and a controller for processing the baseband signal, wherein the controller selectively controls operation of the first amplifier.

According to one aspect of the invention, a noise figure (NF) of the GPS signal is equal to or less than about 1 dB. Preferably, the first amplifier comprises a low noise-type Field Effect Transistor (FET) having a Noise Figure (NF) of about 0.6 dB in a band of about 1500 MHz.

According to another aspect of the invention, the first filter comprises a surface acoustic wave filter.

According to another embodiment, a mobile communication terminal capable of communicating in a radio network and having a global positioning system (GPS) receiver comprises an antenna configured to receive a radio telecommunication signal for terrestrial communication and a GPS signal; an antenna matching circuit coupled to the antenna for impedance matching of the GPS signal; a first amplifier operationally connected to the antenna matching circuit for amplifying the GPS signal; and an RF switch operationally connected to the first amplifier for outputting one of a first amplifier output and another input to a first RF filter. The mobile communication terminal further comprises a second amplifier operationally connected to the RF switch for amplifying a first RF filter output; a second RF filter operationally connected to the second amplifier to provide bandpass filtering; a frequency converter operationally connected to the second RF filter for converting an RF signal to a baseband signal; and a controller for processing the baseband signal, wherein the controller selectively controls operation of the first amplifier.

According to another embodiment, a method of receiving a Global Positioning System (GPS) signal in a mobile communication terminal with a global positioning system (GPS) receiver comprises receiving a radio telecommunication signal for terrestrial communication and a GPS signal through an antenna; matching impedance of the GPS signal; amplifying the GPS signal to reduce noise; and passing a first predetermined band signal of the GPS signal; further amplifying a first bandpassed signal; passing a second predetermined band signal; down converting a second bandpassed signal from RF to a baseband signal; and processing the baseband signal.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a block diagram showing a conventional mobile communication terminal receiver using a tri-band antenna according to the prior art.

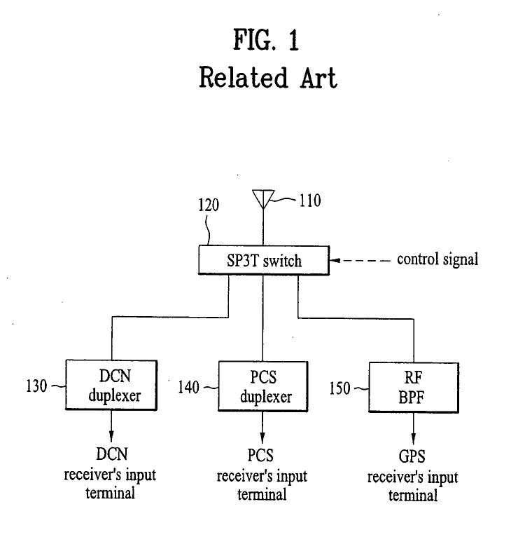

FIG. 2 is a block diagram illustrating a GPS receiver using a tri-band antenna according to the prior art.

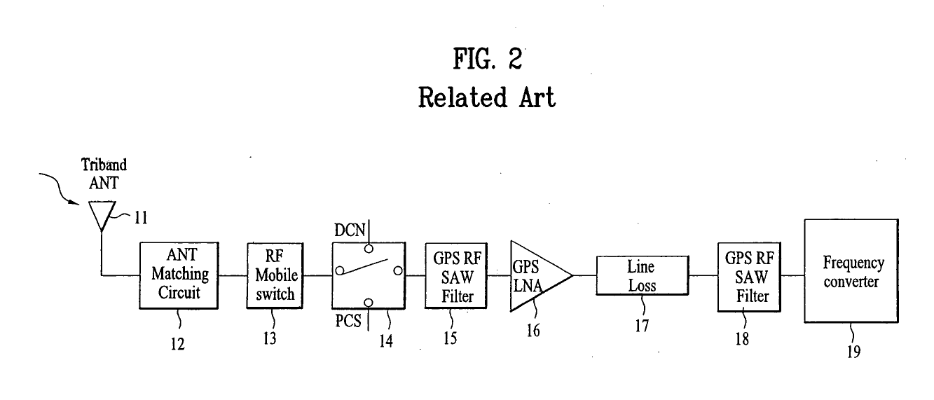

FIG. 3 is a block diagram illustrating a conventional mobile communication terminal receiver a using a GPS antenna according to the prior art.

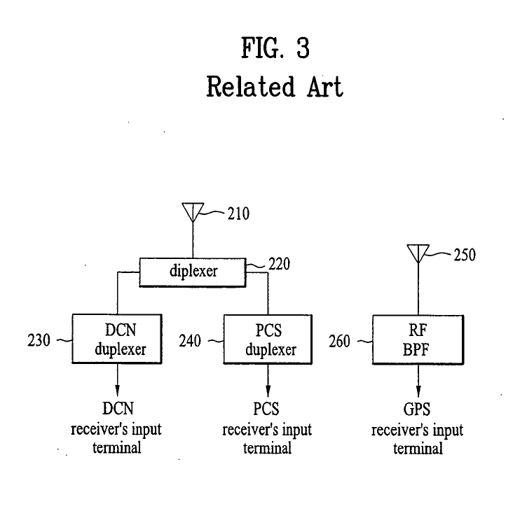

FIG. 4 is a block diagram illustrating a conventional GPS receiver using a GPS antenna according to the prior art.

FIG. 5 is a conceptual diagram illustrating a method for calculating an NF.

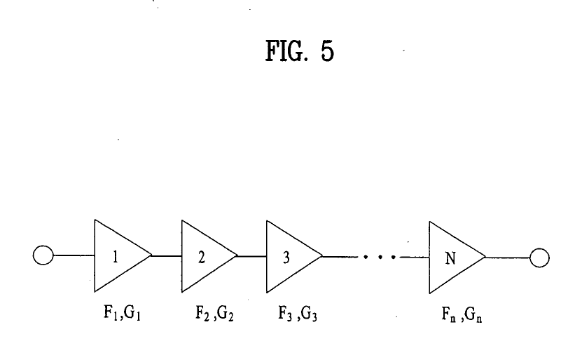

FIG. 6 is a block diagram illustrating a GPS receiver using a GPS antenna according to an embodiment of the present invention.

### DETAILED DESCRIPTION OF THE PREFERRED EMBODIMENTS

Reference will now be made in detail to the embodiments of the present invention, examples of which are illustrated in the accompanying drawings. Wherever possible, the same reference numbers will be used throughout the drawings to refer to the same or like parts.

An apparatus and method for receiving a GPS signal in a mobile communication terminal according to the present invention will hereinafter be described with reference to the annexed drawings.

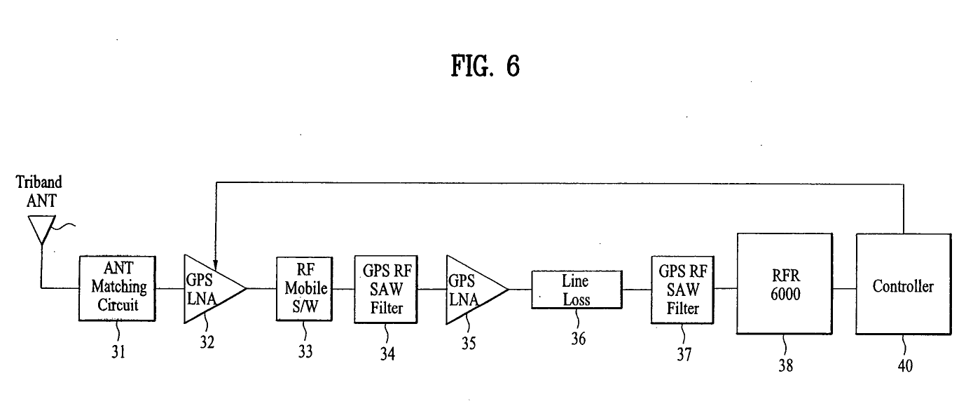

FIG. 6 is a block diagram illustrating a GPS receiver 100 according to a preferred embodiment of the present invention. The GPS receiver 100 comprises a GPS antenna 31 for receiving GPS signals from one or more GPS satellites; an antenna matching circuit 32 for matching impedance of the GPS signal received from the GPS antenna 31; a first GPS LNA 33 for correcting attenuation of a signal received from the antenna matching circuit 32, and for reducing noise of the signal; an RF switch 34 for switching between an input from the antenna 31 and a test input for measuring conductivity performance of a GPS receiver circuit. The GPS antenna 31 may be a dual band or a triband antenna to support different cellular services in addition to a GPS service.

The GPS receiver 100 further comprises a first GPS RF filter 35, preferably a SAW filter, for passing only a predetermined-band signal from among a high-frequency signals received from the first GPS LNA 33; a second GPS LNA 36 for receiving a signal generated from the first GPS RF SAW filter 35, and for amplifying the received signal; and a second GPS RF filter 38, preferably a SAW filter, for passing only a predetermined-band signal from among a high-frequency signals received from the second GPS LNA 36, and for transmitting the passed signal to an frequency converter 39. The frequency converter 39 converts the RF input to a baseband frequency for processing by a controller 40, such as a signal processor. Preferably, the controller 40 the GPS LNA 33, so that the GPS LNA is disabled to save power when the GPS function is not selected.

According to the preferred embodiment, placing the first GPS LNA 33 before the RF switch 34 substantially reduces noise figure, thus improving the input signal quality. The placement of the RF switch 34 causes a significant loss to the GPS receivers. However, the RF switch 34 is necessary for testing of the GPS receiver, and thus all GPS receivers must be equipped with an RF switch. In addition, the use of the second GPS LNA 36 is optional to further amplify the input signal.

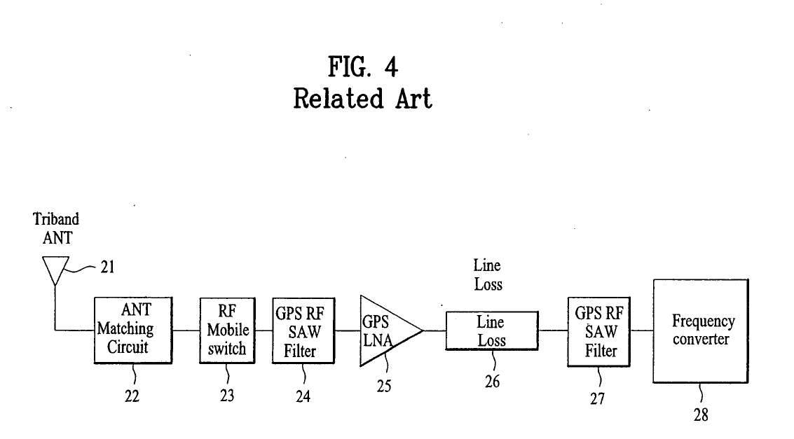

The following Table 3 presents the gain and noise figure data for each of the components used according to the invention shown in FIG. 6. Each of the components is the same as the prior art shown in FIG. 4, but includes the addition of the first GPS LNA positioned before the RF mobile switch.

TABLE 3

| Category | Gain (dB) | NF (dB) |
|---|---|---|
| First GPS LNA | 19 | 0.6 |
| RF mobile switch | −0.6 | 0.6 |
| First GPS RF SAW filter | −0.7 | 0.7 |
| Second GPS LNA | 15 | 1.2 |
| Line loss | −0.5 | 0.5 |
| Second GPS RF SAW filter | −0.7 | 0.7 |
| Frequency converter | 64 | 2 |

According to the preferred embodiment, a total NF is 0.64 dB.

Referring to FIG. 6, a satellite signal is received in the GPS receiver through the GPS antenna 31. The received signal is applied to the first GPS LNA 33 from the antenna matching circuit 32. The first GPS LNA 33 uses a super-low noise-type Field Effect Transistor (FET) having a predetermined NF of about 0.6 dB in a 1500 MHz band. The NF of the first GPS LNA 33 has the NF of 0.6 dB, such that a total NF of a system is contained in a band of 0.6 dB. The signal amplified by the first GPS LNA 33 passes to the RF mobile switch 34 and then to the first GPS RF SAW filter 35. The GPS RF SAW filter 35 acts as a band pass filter passing only a GPS-band signal, and this signal is applied to the frequency converter unit 39 the second GPS LNA 36 and the second GPS RF SAW filter 38.

As previously stated, a conventional system using a tri-band antenna has a total NF of 3.21 dB, and if a conventional GPS antenna is used, a total NF is 2.61 dB. However, the GPS receiver according to the present invention has a total NF of 0.64 dB.

As shown, a system NF according to the present invention is considerably lower than those of the conventional GPS receivers. The reason why the total NF of the present invention is lower than those of the conventional GPS receivers is that the super-low noise-type LNA is located in front of passive components, whereas a conventional system has several passive components are located in front of the GPS LNA. A system having a low NF can be implemented according to the present invention,.

The NF reduction of about 3 dB is considered to be the NF improvement of about 3 dB in light of the NF characteristics. From the viewpoint of system performance, the GPS receiver according to the present invention can use three or more satellites as compared to the conventional GPS receivers during a position calculation process. Generally, the minimum number of satellites for calculating a correct position is 3. If the GPS receiver uses more than three satellites, a position calculation process is made using the best satellite from among a plurality of satellites. The higher the satellites, the higher the position data accuracy. Therefore, the GPS receiver according to the present invention can acquire more accurate position data, resulting in increased efficiency.

As apparent from the above description, the GPS receiver according to the present invention can reduce the mobile communication terminal NF thereby using more satellites to perform a position calculation process. As a result, the GPS receiver acquires more accurate position data resulting in increased efficiency.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A global positioning system (GPS) receiver comprising:
an antenna for receiving a GPS signal;
an antenna matching circuit coupled to the antenna for impedance matching;
a first amplifier operationally connected to the antenna matching circuit for amplifying the GPS signal; and
an RF switch operationally connected to the first amplifier for outputting one of a first amplifier output and another input to a first RF filter.

2. The GPS receiver of claim 1, further comprising:
a second amplifier operationally connected to the RF switch for amplifying a first RF filter output;
a second RF filter operationally connected to the second amplifier to provide bandpass filtering;
a frequency converter operationally connected to the second RF filter for converting an RF signal to a baseband signal; and
a controller for processing the baseband signal, wherein the controller selectively controls operation of the first amplifier.

3. The GPS receiver of claim 1, wherein a noise figure (NF) of the GPS signal is equal to or less than about 1 dB.

4. The GPS receiver of claim 1, wherein the first amplifier comprises a low noise-type Field Effect Transistor (FET) having a Noise Figure (NF) of about 0.6 dB in a band of about 1500 MHz.

5. The GPS receiver of claim 1, wherein the first filter comprises a surface acoustic wave filter.

6. A mobile communication terminal capable of communicating in a radio network and having a global positioning system (GPS) receiver, the mobile communication terminal comprising:
an antenna configured to receive a radio telecommunication signal for terrestrial communication and a GPS signal;
an antenna matching circuit coupled to the antenna for impedance matching of the GPS signal;
a first amplifier operationally connected to the antenna matching circuit for amplifying the GPS signal; and
an RF switch operationally connected to the first amplifier for outputting one of a first amplifier output and another input to a first RF filter.

7. The mobile communication terminal of claim 6, further comprising:
a second amplifier operationally connected to the RF switch for amplifying a first RF filter output;
a second RF filter operationally connected to the second amplifier to provide bandpass filtering;
a frequency converter operationally connected to the second RF filter for converting an RF signal to a baseband signal; and
a controller for processing the baseband signal, wherein the controller selectively controls operation of the first amplifier.

8. The mobile communication terminal of claim 6, wherein a noise figure (NF) of the GPS signal is equal to or less than about 1 dB.

9. The mobile communication terminal of claim 6, wherein the first amplifier comprises a low noise-type Field Effect Transistor (FET) having a Noise Figure (NF) of about 0.6 dB in a band of about 1500 MHz.

10. The mobile communication terminal of claim 6, wherein the first filter comprises a surface acoustic wave filter.

11. A method of receiving a Global Positioning System (GPS) signal in a mobile communication terminal with a global positioning system (GPS) receiver, the method comprising:
receiving a radio telecommunication signal for terrestrial communication and a GPS signal through an antenna;
matching impedance of the GPS signal;
amplifying the GPS signal to reduce noise; and
passing a first predetermined band signal of the GPS signal.

12. The method of claim 11, further comprising:
further amplifying a first bandpassed signal;
passing a second predetermined band signal;
down converting a second bandpassed signal from RF to a baseband signal; and
processing the baseband signal.

13. The method of claim 11, wherein a noise figure (NF) of the GPS signal is equal to or less than about 1 dB.
